(19) United States
(12) Patent Application Publication
(10) Pub. No.: US 2022/0015365 A1
(43) Pub. Date: Jan. 20, 2022

(54) SYNERGISTIC HERBICIDE COMPOSITION OF BROAD-SPECTRUM FOR THE CONTROL OF WEEDS IN AGRICULTURAL CULTURES, USE OF SUCH COMPOSITION FOR PREPARATION OF PRODUCT, PRODUCT AND METHOD OF APPLICATION

(71) Applicants: Giuvan Lenz, Tatuí (BR); Daniel Marques Forlivio, Piracicaba (BR); Marc Bonnet, Liège (BE); Luis Gustavo Rodrigues Gonella, Tatuí (BR); Luiz Carlos Vieira de Campos, Piedade (BR); Carlos Eduardo Ribas Peres, São Paulo (BR)

(72) Inventors: Giuvan Lenz, Tatuí (BR); Daniel Marques Forlivio, Piracicaba (BR); Marc Bonnet, Liège (BE); Luis Gustavo Rodrigues Gonella, Tatuí (BR); Luiz Carlos Vieira de Campos, Piedade (BR); Carlos Eduardo Ribas Peres, São Paulo (BR)

(21) Appl. No.: 17/294,751

(22) PCT Filed: Dec. 4, 2019
(86) PCT No.: PCT/BR2019/050520

§ 371 Date: May 18, 2021

(30) Foreign Application Priority Data
Dec. 4, 2018 (BR) 10 2018 075132.8

(51) Int. Cl. A01N 47/38; A01N 43/84; A01P 13/00

(52) U.S. Cl. CPC A01N 47/38; A01P 13/00; A01N 43/84

(57) ABSTRACT

The present invention refers to an inventive solution that offers a significant benefit to the agricultural sector, with abroad spectrum of application, as an aid in the cultivation of all sorts of plants of agricultural interest, with a greater objective of promoting the enhancement of herbicide efficiency regarding weeds, for which purpose a composition was devised comprising a first herbicide belonging to the group whose mechanism of action acts as a photosystem II inhibitor and a second herbicide belonging to the group whose mechanism of action acts as an inhibitor of the enzyme protoporphyrinogen oxidase which together enhance their respective mechanisms of action and consequently increase their efficiency in the eradication of weeds. Furthermore, the present invention refers to the use of this composition for the preparation of a herbicide product and the method of application of said composition for combating weeds.

### FIELD OF APPLICATION

The present invention refers to a solution which offers a significant benefit to the agricultural sector, with a broad spectrum of application, as an aid in the cultivation of all sorts of plants of agricultural interest, such as in the cultivation of rice, corn, sorghum, wheat, barley, oats, cereals, triticale, soybeans, beans (and their varieties, such as dried beans), cotton, fruits (and their varieties such as peaches, apples, pineapples and tomatoes), potatoes, sweet potatoes, canola, flax, peas, lentils, mustard, chickpeas, sunflowers, alfalfa, onions, herbage, sugar cane, beetroot, saccharin, turmeric, cassava, cucurbits, and others.

This list of plants of agricultural interest is not limiting of the broad spectrum of application, and can be extended to all sorts of plant classified as such, duly known to the state of the art or which may be catalogued in the future.

The present invention refers to a broad-spectrum synergistic herbicide composition for the control of weeds in agricultural crops, such as those mentioned above, which comprises at least two herbicides, being a herbicide belonging to the group whose mechanism of action acts as a photosystem II inhibitor in combination with at least one herbicide belonging to the group whose mechanism of action acts as an inhibitor of the enzyme protoporphyrinogen oxidase.

### GROUNDS OF THE INVENTION

In order to demonstrate the veracity and clarify the context described in the introductory section, a brief explanation shall be provided on the state of the art for pesticide products, notably herbicides, where we shall present the understanding of people skilled in the art concerning their technical effects on the agricultural crops that benefit from their application, and the restrictive aspects of this agricultural management practice, thus establishing the range of needs previously described in the section concerning the demand for this invention.

a. Productivity in the cultivation of agricultural crops of interest: this is determined by several factors, principally:
the variety of the agricultural crop of interest;
the soil (physical, chemical and biological properties);
the climate of the region;
pest control; and
weed control.

For the purposes of the present invention, it is pertinent to focus on the weed control factor in general, which is to say, the entire scope of weeds that affect every sort of agricultural crop of interest is considered.

Merely by way of example, without having any limiting effect, a list of some weeds responsible for reductions in the productivity of agricultural crops is presented below in Table 1:

TABLE 1
Some weeds present in agricultural crops:

| Scientific name | Popular name |
|---|---|
| Brachiaria plantaginea | Signal grass |
| Panicum maximum | Guinea grass |
| Brizantha Brachiaria | Bread grass |
| Cenchrus echinatus | Southern sandbur |
| Amaranthus sp | Spiny amaranth |
| Portufaca oleracea | Verdolaga |
| Cleomis affinis | Prickly spiderflower |

b. The use of herbicides to combat weeds in agricultural crops: this is one of the most effective ways of controlling weeds, without damaging the agricultural crop of interest. A herbicide should be understood here as an active ingredient that kills, controls or adversely modifies plant growth. It can also cause deviations from natural development, death, regulation, desiccation, retardation and the like. While herbicide activity is performed by the chemical compounds present in the composition when they are applied directly to the plant or at the site of the plant in any growth phase or before planting or in an emergency. Furthermore, the effect observed depends on several factors such as the plant species to be controlled, the plant growth stage, the conditions of the application of the composition considering drop size and the particles of the components, as well as other factors such as environmental conditions, adjuvants, excipients and vehicles used, soil type as well as the quantity and quality of the chemical product applied.

For success in the combating of weeds, it is necessary to have in-depth knowledge of factors such as: the physiology of the herbicides in the plant, the factors involved in the selectivity and behavior of the herbicides in the soil.

c. Mechanisms of action of herbicides: this is defined as the first chemical or physical reaction that is affected inside the cell of the weed and which results in the alteration of its growth, with the principal known mechanisms being listed below:

c.1. Growth regulators or auxin mimics: these present greater action on dicotyledonous weeds; they cause disorganization in plant growth, acting on the meristematic tissues; they present translocation predominantly through the symplast;

c.2. Mitosis inhibitors and initial growth: the group of the dinitroanilines presents characteristics such as the control of more grasses; it does not possess post-emergency activity; it is absorbed by caulicles and radicles; it does not present translocation; it does not control perennial weeds and acts by inhibiting cell division;

c.3. Amino acid synthesis inhibitors: notably inhibitors of the ALS enzyme, they promote apo-symplastic translocation; EPSPS enzyme inhibitors that inhibit the synthesis of phenylalanine, tyrosine and tryptophan amino acids, they are not selective; they control dicotyledonous weeds and grasses, symplastic translocation;

c.4. Pigment inhibitors: they act on the biosynthesis of carotenoids, producing albino tissues; chlorophyll loss is due to oxidation by light (photooxidation), a consequence of the lack of carotenoids that protect it; translocation is apoplastic;

c.5. Respiration inhibitors: they present translocation restricted by the symplast; they are used in post-emergency situations; they mostly control grasses; high temperatures and luminosity increase their effectiveness;

c.6. Membrane destroyers: they inhibit the enzyme protoporphyrinogen oxidase (PROTOX); the symptoms are dark green spots on the leaves, which evolve into necrosis; they present reduced apoplastic translocation; and

c.7. Photosystem II inhibitors: in this group are the triazines, triazinones, the substituted ureas and the uracils. Triazines are usually used in pre-emergency or early post-emergency situations, they are effective for dicotyledonous weeds and some grasses, and present apoplastic translocation.

d. Scope of the chemical groups by mechanism of action: for the purposes of the present invention, only the mechanisms inhibiting of the photosystem II and inhibitors of the enzyme protoporphyrinogen oxidase (PROTOX), membrane destroyers, are considered, to which belong the herbicides of the triazolinone chemical groups and at least one herbicide selected from the group of the cyclohexene dicarboximides, respectively.

d.1. Group of Inhibitors of PSII Photosynthesis: for the purposes of the present invention, “amicarbazone” was chosen as an active ingredient belonging to this group of mechanism of action, and the active ingredient amicarbazone should additionally be considered in all its forms and variations.

d.1.1. Active ingredient amicarbazone: its technical specification is presented in a preferred form of realization in Table 2 below:

TABLE 2
Amicarbazone - Technical specifications

| | |
|---|---|
| Formula | C₁₀H₁₉N₅O₂ |
| Compound | 4-Amino-N-(tert-butyl)-3-isopropyl-5-oxo-4,5-dihydro- |
| | 1H-1,2,4-triazole-1-carboxamide |
| Compounds | 4-amino-N-tert-butyl-5-oxo-3-(propan-2-yl)-4,5-dihydro- |
| [others] | 1H-1,2,4-triazole-1-carboxamide |
| | 4-amino-N-tert-butyl-4,5-dihydro-3-isopropyl-5-oxo-1H- |
| | 1,2,4- triazole-1-carboxamide |
| | 4-amino-N-(1,1-dimethylethyl)-4,5-dihydro-3-(1- |
| | methylethyl)-5-oxo-1H-1,2,4-triazole-1-carboxamide |
| Action | inhibition of photosynthesis II |

d.1.2. Critical analysis: despite its qualities having been proven over the last decades, the herbicide amicarbazone selected from the triazolinone group and notably belonging to the group of PSII Photosynthesis Inhibitors, applied in isolation, has presented restrictive results, displaying for people skilled in the art reduced control of the target plant, a shorter residual period and reduced list of weeds controlled at the same time.

This decrease in the effectiveness of the action of the herbicide “amicarbazone” can be explained by the fact that the intrinsic activity of this active ingredient does not provide effective control for the entire list of weeds.

Finally, it is possible to affirm that the situation of the progressive loss of effectiveness of the active ingredient “amicarbazone” can be extended to all the active ingredients belonging to the group of mechanism of action that includes the Photosynthesis II inhibitors.

d.2. PROTOX Inhibitor Group: also called protoporphyrinogen oxidase enzyme inhibitors, where for the purposes of the present invention, the active ingredient “flumioxazin” of the chemical group “cyclohexene dicarboximides” belonging to this group of mechanism of action was chosen, and should be considered in all its forms and variations.

d.2.1. Active ingredient flumioxazin: its technical specification is presented in one preferred form of embodiment in Table 3 below:

TABLE 3
Flumioxazin - Technical specifications

| | |
|---|---|
| Formula | C₁₉H₁₅FN₂O₄ |
| Compound | N-(7-Fluor-3,4-dihydro-3-oxo-4-prop-2-inyl-2H-1,4- |
| | benzoxazin-6-yl)cyclohex-1-en-1,2-dicarboximide |
| Action | inhibition of protoporphyrinogen oxidase (PPO) |

d.2.2. Critical analysis: despite its qualities having been proven over the past few decades, the herbicide “flumioxazin” selected from the group of “cyclohexene dicarboximides” and notably belonging to the group of inhibitors of the enzyme protoporphyrinogen oxidase [PROTOX], applied in isolation, has presented limited results, demonstrating to persons skilled in the art reduced control of the target weed, a shorter residual period and a smaller list of weeds controlled at the same time.

This decrease in the effectiveness of the action of the herbicide “flumioxazin” can be explained by the fact that the intrinsic activity of this active ingredient does not provide effective control for the entire list of weeds.

Finally, it is possible to affirm that the scenario of the progressive loss of efficiency of the active ingredient Flumioxazin can be extended to all the active ingredients belonging to the group whose mechanism of action inhibits the enzyme protoporphyrinogen oxidase [PROTOX].

Below are some teachings of the state of the art that refer to the present matter:

Patent documents EP-A 294 666, EP-A 370 293, EP-A 391 187, EP-A 398 096, EP-A 399 294, EP-A 415 196 and EP-A 477,646 describe a process for obtaining and/or applying carbamoyl triazolinones, for example, where the active ingredient is always considered in isolation.

While patent documents PI9603223-5 and PI9603448-3 reveal the process for obtaining substituted amino carbonyl triazolinones and substituted amino triazolinones respectively, also in isolation.

Moreover, patent documents JP 61-76486 A and JP 5-97848 describe a method for producing flumioxazin.

Patent document BR 112014019707-5 refers to flumioxazin crystal, where the active ingredient is also always cited in isolation.

There are also patent documents that reveal combinations or compositions comprising one of the two active ingredients mentioned above as well as applications/methods such as BR 10 2017 023313 8, BR 10 2016 007767 2, BR 11 2017 015652 0, BR 10 2013 009023 9, BR 11 2013 018114 1, PI 0413082-0, PI 0302668-0, PI 0211275-2, PI 0015670-1, PI 9704565-9, PI 9509362-1 and PI 92059999-6.

The results of the individual application, both of the active ingredient amicarbazone and flumioxazin, according to people skilled in the field of agricultural crop management with emphasis on the application of herbicides, lead to a first and correct conclusion that the resistance of weeds to them is due to these having acquired reduced sensitivity to mechanisms of action like PSII Photosynthesis Inhibitors and inhibitors of the enzyme protoporphyrinogen oxidase [PROTOX] respectively.

As a result, given that the mechanisms of action so far discussed are the cause of the restricted performance of the active ingredients amicarbazone and flumioxazin, it is concluded that this effect extends to all herbicides whose active ingredients belong to the same groups of mechanisms of action.

Thus, there is no solution in the state of the art equivalent to that presented here in the present invention, which combines technical differentiating factors, economic advantages, safety and reliability.

### Terminology

For the purposes of better understanding the present invention, the meaning of some terms cited in the text of the specification is presented below:

Commodity: a term used mainly in reference to base products in a raw state (raw materials) or with a small degree of industrialization, of almost uniform quality, produced in large quantities by different producers. These “in natura” products can be stocked for a given period without significant loss of quality, depending on their conservation and are subject to global quotation and trading, using commodities trading exchanges. For the purposes of the present invention a plant of agricultural interest is a commodity;

Synergy: in general, this can be defined as a combination of two elements such that the result of this combination is greater than the sum of the results that these elements would have separately. It is an unexpected result only achieved by bringing the components into contact, and therefore it is not possible to predict, infer or suggest;

Plants: includes germinating seeds, cuttings, emerging seedlings and established vegetation, including roots and portions above the ground, for example leaves, stems, flowers, fruits, branches, limbs, roots and the like;

Plant of agricultural interest: should be understood as any type of plant intended for commercial consumption, and may be of the edible or inedible plant type, floral or non-floral, trees, grasses [couch grass, herbs or grass];

Weeds: according to Lorenzi (2014) this is any plant that grows where it is not desired, interfering directly and indirectly in the crops of interest, causing significant reductions in the overall productivity of these crops;

Biotic factors: this can be understood as the sum of all the effects caused by the organisms in an ecosystem, which condition the populations that form it, and for the present invention the organisms are understood to be weeds;

Agrochemicals: also known as insecticides, pesticides, biocides, plant pharmaceuticals or plant sanitary products are generic terms for the various chemicals used in agriculture. The World Health Organization (WHO) defines a pesticide or insecticide as any substance capable of controlling a pest that can pose a risk or nuisance to populations and the environment. They may also be defined as substances or mixtures of substances intended to prevent the action of or directly kill insects (insecticides), mites (acaricides), molluscs (molluscicides), rodents (rodenticides), fungi (fungicides), weeds (herbicides), bacteria (antibiotics and bactericides) and other forms of animal or plant life harmful to public health and agriculture;

Herbicide: constitutes a type of pesticide, a chemical product used in agriculture for the control of herbs classified as weeds;

Herbicide of interest: any formulation in a commercially known herbicide, the technical effects of whose application are the object of a need for enhancement and whose harmful effects are the object of minimization;

Active ingredient: for the purposes of the present invention this is defined as the main chemical substance of the herbicide;

Ha: hectare, unit of measurement for agrarian surfaces corresponding to one hundred ares or a square hectometer (10,000 m²);

Colby Method: one of the most widely used for proving the synergism of associations, used in the present invention for the calculation of the expected response in the interaction between the herbicides of interest;

Herbicide Resistance Action Committee [HRAC]: group of experts, linked to industry and recognized as a consulting body by the Food and Agriculture Organization (FAO) and the United Nations World Health Organization (WHO);

The list of terms, technologies and technical concepts presented in this section should be considered for a correct understanding of the present invention, conferring the necessary descriptive sufficiency on the text of the specification, and should be used as a reference for studies in comparative analyses, either for hypothetical solutions of the state of the art that anticipate the invention and are not mentioned here, or for products of the same nature and the same international patent classification (CPI), disclosed and/or marketed by holders or third parties who are not the holders of this patent.

### OBJECTIVES OF THE INVENTION

Therefore, it is an objective of the present invention to provide a herbicide composition that meets the need to enhance the effects of herbicide-type pesticides, considering the inevitable fact that the agricultural crop plants of interest are subject to biotic factors.

It is another objective of the present invention to provide a herbicide composition capable of combating a numerous list of weeds.

It is another objective of the present invention to provide a herbicide composition comprising herbicides already known to the state of the art that offers a better result than those currently known because the development of new molecules is increasingly difficult and costly.

It is another objective of the present invention to provide a herbicide composition that comprises herbicides already known to the state of the art which offers a better result than those currently known because the progressive impairment of the effectiveness of the application in isolation of herbicide inhibitors of PSII photosynthesis and the protoporphyrinogen oxidase enzyme [PROTOX] respectively, is well known.

Furthermore, it is another objective of the present invention to develop a herbicide composition comprising known components even having a limited number of alternative herbicides for use to control resistant biotypes (the number of active ingredients available to control some weed species is restricted).

Furthermore, it is another objective of the present invention to develop a herbicide composition that regains the efficiency close to that recorded at the time of the first use both of PSII Photosynthesis inhibitor herbicides and protoporphyrinogen enzyme oxidase [PROTOX] inhibitors, respectively, i.e. to demonstrate efficiency close to 100% in the elimination of all sorts of weeds from the most varied agricultural crops of interest.

It is another objective of the present invention to provide a herbicide composition that provides advantages from the agroindustrial, commercial and technical points of view.

Moreover, it is an objective of this invention to help increase the productivity of the harvest of an agricultural crop of interest, notably for its effectiveness in controlling biotic factors.

Furthermore, it is an objective of this invention to obtain the synergistic effect of restoring the efficiency of herbicides as a photosystem II inhibitor in combination with restoring their effectiveness as inhibitors of the enzyme protoporphyrinogen oxidase [PROTOX].

### ABSTRACT OF THE INVENTION

The present invention achieves these and other objectives through a synergistic herbicide composition that comprises:
a quantity varying from 1.0% to 99.0%, by weight, of a first herbicide belonging to the group whose mechanism of action acts as a photosystem II inhibitor; and
a quantity varying from 1.0% to 99.0%, by weight, of a second herbicide belonging to the group whose mechanism of action acts as an inhibitor of the enzyme protoporphyrinogen oxidase;
an acceptable vehicle;

The quantities are based on the total mass of the herbicide composition.

The present invention achieves these and other objectives through a herbicide product comprising the herbicide composition above and at least one excipient.

The present invention achieves these and other objectives through the use of the herbicide composition above in the preparation of a herbicide product to be used to combat weeds present in agricultural crops.

Furthermore, the present invention achieves these and other objectives through a method of application of the herbicide composition above and/or the herbicide product above to combat weeds in agricultural crops in a preventive or corrective way.

### DETAILED DESCRIPTION OF THE INVENTION

With expertise in the cultivation of agricultural crops, the need to enhance the effects of herbicide-type pesticides was identified, considering the inevitable fact that the agricultural crop plants of interest are subject to biotic factors.

a. Motivation for the development of the present invention: it is a well-known fact to those skilled in the management of agricultural crops in general that, if on the one hand, the use of herbicides promotes the effective combat of weeds, leading to a reduction in productivity losses per area [hectare] of the plantation, on the other hand, it has been found that the list of plants that have acquired resistance to the action of this class of pesticides is ever increasing.

VARGAS, L.; ROMAN, E. S. in the published study under the heading “Weed resistance to herbicides: concepts, origin and evolution”. Passo Fundo: Embrapa Trigo, 2006. 22 p. html. (Embrapa Trigo. Documents Online, 58), state that “[ . . . ] Weed resistance to herbicides is of great importance, mainly due to the limited number of alternative herbicides available for use to control resistant biotypes. The number of active ingredients available to control some weed species is restricted, and the development of new molecules is increasingly difficult and costly. The occurrence of multiple resistance further aggravates the problem, since in this case two or more mechanisms need to be replaced. Thus, the control of resistant biotypes through the use of herbicides is compromised, which restricts this practice to other less efficient methods.”

In accordance with the demand for the invention, a “broad-spectrum synergistic herbicide composition was developed for the control of weeds in agricultural crops, comprising at least one herbicide belonging to group whose mechanism of action acts as an inhibitor of photosystem II in association with at least one herbicide belonging to the group whose mechanism of action acts as an inhibitor of the enzyme protoporphyrinogen oxidase”, the object of the present invention. This composition does not derive in an obvious or evident manner from other combination-based herbicide management techniques for the cultivation of agricultural species of interest anticipated by the state of the art, conferring advantages from the agroindustrial, commercial and technical points of view.

It is noteworthy that the present invention provides an innovative composition comprising, in an original manner, at least one herbicide belonging to the group whose mechanism of action acts as an inhibitor of photosystem II in association with at least one herbicide belonging to the group whose mechanism of action acts as an inhibitor of the enzyme protoporphyrinogen oxidase.

In addition to this, an unexpected synergistic effect is surprisingly observed after the management of the agricultural crops of interest with the application of the herbicide composition consisting of, at least, one herbicide belonging to the group whose mechanism of action acts as an inhibitor of photosystem II in association with at least one herbicide belonging to the group whose mechanism of action acts as an inhibitor of the enzyme protoporphyrinogen oxidase, notably with the application of the Colby method used to demonstrate the synergism of the control.

It is also worth noting the originality of applying this synergistic herbicide composition to weeds.

a. The synergistic herbicide composition:

a.1. General combination: for the purposes of this invention it is defined using the following formula:

C=A+B

Where:

C=Combination of at least one herbicide [A] belonging to the group whose mechanism of action acts as an inhibitor of photosystem II in combination with at least one herbicide [B] belonging to the group whose mechanism of action acts as an inhibitor of enzyme protoporphyrinogen oxidase, both membrane destroyers [PROTOX];

A=herbicide belonging to the group whose mechanism of action acts as an inhibitor of photosystem II, selected from the list of the group of active ingredients and respective chemical groups, listed in Table 4 below:

TABLE 4
Scope of possibilities for Herbicide [A]

| Chemical Group | Active Ingredient |
|---|---|
| Triazolinones | Amicarbazone |
| Triazines | Ametrine |
| | Atrazine |
| | Desmetryn |
| | Propazine |
| | Terbuthylazine |
| | Symetryn |
| | Dimethametryn |
| | Prometon |
| | Terbutryn |
| | Simazine |
| | Cyanazine |
| | Prometryn |
| | Terbumeton |
| | Trietazine |
| Triazinones | Hexazinone |
| | Metamitron |
| | Metribuzin |
| Ureas | Chlorobromuron |
| | Fenuron |
| | Metobromuron |
| | Neburon |
| | Chlorotoluron |
| | Fluometuron |
| | Methabenzthiazuron |
| | Siduron |
| | Chloroxuron |
| | Isoproturon |
| | Metoxuron |
| | Isouron |
| | Dimefuron |
| | Monolinuron |
| | Ethidimuron |
| | Diuron |
| | Linuron |
| | Tebuthiuron |
| Uracils | Bromacil |
| | Lenacil |
| | Terbacil |
| Pyridazinones | Chloridazon/pirazon |
| Phenylcarbamates | Desmedipham |
| | Phenmedipham |
| Amides | Pentanochloro |
| | Propanil |
| Nitriles | Bromofenoxim |
| | Bromoxynil |
| | Ioxynil |
| Phenyl-pyridazines | Pyridate |
| | Pyridafol |
| Benzothiadiazinones | Bentazone |

The list of chemical groups and their active ingredients listed in Table 4 is not exhaustive and for the purposes of this invention all and any herbicide should be considered whose active ingredient and respective chemical group is or may come to be classified as belonging to the group whose mechanisms of action inhibit photosystem II by the Herbicide Resistance Action Committee [HRAC].

B=herbicide belonging to the group whose mechanism of action acts as an inhibitor of the enzyme protoporphyrinogen oxidase [PROTOX], selected from the list of active ingredients and respective chemical groups, listed in Table 5 below:

TABLE 5
Scope of possibilities for Herbicide [B]

| Chemical Group | Active Ingredient |
|---|---|
| Diphenyl ethers | Acifluorfen-sodium |
| | Biphenox |
| | Ethoxyphenethyl |
| | Halosafen |
| | Chlomethoxyphen |
| | Fluoroglicofen-Ethyl |
| | Fomesafen |
| | Lactofen |
| | Oxyfluorfen |
| Phthalimides | Flumichlorac |
| | Flumioxazin |
| | Cinidon-Ethyl |
| | Flumichlorac-Pentyl |
| Triazolinones | Carfentrazone-Ethyl |
| | Sulfentrazone |
| | Azaphenidin |
| | Bencarbazone |
| Oxadiazoles | Oxadiazon |
| | Oxadiargyl |
| Pyrimidinediones | Saflufenacil |
| | Benzfendizone |
| | Butafenacil |
| Phenylpyrroles | Fluazolate |
| | Pyraflufen-Ethyl |
| Thiadiazols | Fluthiacet-methyl |
| | Thidiazimin |
| Oxazolidinediones | Pentoxazone |
| Other | Flufenpyr-Ethyl |
| | Pyraclonil |
| | Profluazol |

The list of chemical groups and their active ingredients listed in Table 5 is not exhaustive, and for the purposes of this invention it should encompass any herbicide whose active ingredient and respective chemical group is or may come to be classified as belonging to the group of mechanisms of action that inhibit the enzyme protoporphyrinogen oxidase [PROTOX] by the Herbicide Resistance Action Committee [HRAC].

Thus, the present invention refers to a synergistic herbicide composition comprising:
a quantity ranging from 1.0% to 99.0%, by weight, of a first herbicide belonging to the group whose mechanism of action acts as a photosystem II inhibitor;
a quantity ranging from 1.0% to 99.0%, by weight, of a second herbicide belonging to the group whose mechanism of action acts as an inhibitor of the enzyme protoporphyrinogen oxidase; and
an acceptable vehicle;
where the quantities are based on the total mass of the herbicide composition.

Preferably, the synergistic herbicide composition that is the object of the present invention comprises from 5 to 6 parts, by weight, of a first herbicide belonging to the group whose mechanism of action acts as a photosystem II inhibitor for a part, by weight, of a second herbicide belonging to the group whose mechanism of action acts as inhibitor of the enzyme protoporphyrinogen oxidase and an acceptable vehicle, where the quantities were based on the total mass of the herbicide composition.

Together, these herbicides enhance their respective mechanisms of action and consequently increase their efficiency in the eradication of weeds.

The components of the synergistic composition of the present invention can be applied separately or as part of a multipart herbicide system.

Furthermore, the composition that is the object of the present invention can be applied in conjunction with one or more other herbicides and/or biocides to control a wider variety of undesirable vegetation. Preferably, a herbicide or biocide is added to the composition of the present invention, which herbicides are selective for the crop to be treated and which complement the spectrum of weeds controlled by these compounds at the rate of application used. Some of the herbicides that can be used in conjunction with the synergistic composition of the present invention, but without restricting this, include: propisochlor, s-metholachlor, acetochlor, clethodim, quizalofop, diquat, glufosinate ammonium, pyroxasulfone, imazethapyr, diclosulam, saflufenacil, glyphosate, 2,4-D, triclopyr, dicamba, atrazine, chlorimuron, diuron, sulfentrazone, isoxaflutole, picloram, tebuthiuron, tembotrione, mesotrione.

In preferred embodiments, the first herbicide belonging to the group whose mechanism of action acts as a photosystem II inhibitor is amicarbazone and the second herbicide belonging to the group whose mechanism of action acts as an inhibitor of the enzyme protoporphyrinogen oxidase is flumioxazin.

Optionally, the composition that is the object of this invention preferably comprises water as a vehicle.

The synergistic herbicide composition that is the object of the present invention can be used for the preparation of herbicide products. Thus, herbicide products comprise the composition that is the object of the present invention and other optional components such as:
herbicides/biocides/pesticides/larvicides/fungicides/insecticides;
herbicide protectors;
vehicles and solvents;
oils;
emulsifiers/surfactants;
compatibility agents;
antifoaming agents;
sequestrating agents;
neutralizing agents and buffers;
corrosion inhibitors;
dyes;
fragrances;
dispersal agents;
penetration aids;
adherent agents;
dispersing agents;
thickening agents;
freezing point depressors;
antimicrobial agents;
plant growth regulators;
other components usually applied to herbicide products.

The present invention also refers to a method of application of the synergistic herbicide composition that is the object of the present invention for combating weeds in plantations.

This method comprises the following steps:
A) selecting an area of an agricultural plantation;
B) applying a sufficiently effective quantity of the herbicide composition of the present invention or the herbicide product of the present invention to each plant or the environment.

This composition may be applied to any vegetable part of the plants present in the crop directly or by allowing the compounds to act in the environment. The application of the composition or the ready product can occur in various ways, such as immersion, spraying, evaporation, mist, applying directly to the seeds and also applying directly to the soil, to parts of leaves, and to straw on the soil among other possibilities.

a.2. Preferred embodiment: bearing in mind the general formulation, for the purposes of the present invention, a preferred form of realization of the herbicide composition of the present invention is provided, which will be represented by the derivative formula:

C1=A1+B1

Where:

C1=a dual herbicide combination of amicarbazone+flumyoxazin;

A1=the active ingredient amicarbazone;

B1=the active ingredient flumioxazin.

b. Form of presentation: any form of presentation should be considered such as the following: encapsulated suspension, dispersible concentrate, emulsifiable concentrate, emulsion of water in oil, emulsion of oil in water, microemulsion, concentrated suspension, suspicion-emulsion, soluble granules, soluble concentrate, soluble powder, tablet, tablet for direct application, tablet for dissolution in water, tablet for dispersion in water, dispersible granules, wettable powder, block, concentrated gel in paste, emulsifiable gel, water soluble gel, emulsifiable granule, emulsifiable powder, oil dispersion or suspension concentrated in oil, dispersible or miscible suspension concentrated in oil, miscible solution in oil, powder dispersible in oil, encapsulated granules, dry powder, liquid for electrostatic/electrodynamic spraying, granules, oil for spray/spreading, ultra-low volume suspension, ultra-low volume, microgranules, fine powder, fine granules, contact powder, tablet for direct application, liquid or contact gel, concentrated suspension for direct application, other liquids for direct application, other powders, powder for dry treatment of seeds, emulsion for treatment of seeds, concentrated suspension for treatment of seeds, solution for treatment of seeds, soluble powder for treatment of seeds, powder for preparation of paste in oil, powder for preparation of paste in water, encapsulated suspension for treatment of seeds, gel for treatment of seeds, aerosol, fumigant, fumigant insert, fumigant candle, fumigant cartridge, fumigant rod, fumigant tablet, fumigant granule, liquefied gas under pressure, gas generator, concentrate for thermonebulization, concentrate for cold nebulization, lacquer, vegetable rod, paste, bait, bait grains, block bait, granulated bait, bait in plates, bait in scraps, steam producer, oily paste, formulated bag, adjuvant, spreader and adhesive spreader.

c. Test: in order to prove the synergy observed between the herbicide compounds present in the composition that is the object of the present invention, the results of the tests performed are presented below.

Protocol: in soil prepared with weed seeds (without germination), the composition of the present invention was applied. This test was performed for two species of weeds: Brachiaria decumbens and Panicum maximum. Data were collected 35 days after application of the composition to the soil and calculated.

d. Proof of the synergistic effect: for the purposes of the present invention, the proof of the synergistic effect is based on two pillars: the Colby equation and submission of the test results to the aforementioned equation, which will duly be discussed.

d.1. Colby equation: to use Colby's approach to evaluate synergy or antagonism in combinations, the components of the combination should be tested individually in their concentration of components in the same study as the combination.

The results observed for the combination are compared with the expected results of the Colby Equation (Colby, 1967). Note that this equation is derived from the definition of the probability of independence.

Assuming that the answers vary within the percentage range of 0 to 100% of pest reduction the Colby Equation is given by the following formula:

Ex+(100−X)(Y/100) (1)

X+Y−X*Y/100

Where:

X=Result observed active ingredient [A1] amicarbazone in p grams ai/ha;

Y=Result observed active ingredient [B1] flumioxazin in q grams ai/ha;

E=Expected result for the combination of active ingredients [A1] amicarbazone and [B1] flumioxazin in (p+q) grams ai/ha if there is no synergy or antagonism.

d.2. Criteria of the analysis:
If the value observed is higher than expected (Obs>E): synergy;
If the value observed is lower than expected (Obs<E): antagonism.

d.3. Comparative analysis: having as a paradigm of study table 6 previously presented, the analysis of synergism or antagonism for the test is presented in a remissive manner through tables 6 and 7 below:

TABLE 6
Test results - Synergistic activity verified 35 days after application

Rate of Application

| | | |
|---|---|---|
| Amicarbazone | Flumioxazin | Control % |

| | |
|---|---|
| rate in grams of active | PANMA |

| | | |
|---|---|---|
| ingredient/ha | Observed | Expected |

| | | | |
|---|---|---|---|
| 238.00 | 0.00 | 83.25 | — |
| 0.00 | 380.00 | 97.50 | — |
| 238.00 | 380.00 | 100.00 | 99.58 |
| 317.30 | 0.00 | 75.00 | — |
| 0.00 | 507.70 | 98.75 | — |
| 317.30 | 507.70 | 100.00 | 99.69 |
| 442.00 | 0.00 | 0.00 | — |
| 0.00 | 176.80 | 97.55 | — |
| 442.00 | 176.80 | 100.00 | 99.90 |
| 589.30 | 0.00 | 90.00 | — |
| 0.00 | 235.70 | 99.00 | — |
| 589.30 | 235.70 | 100.00 | 99.90 |
| 515.60 | 0.00 | 90.00 | — |
| 0.00 | 103.10 | 98.75 | — |
| 515.60 | 103.10 | 100.00 | 99.88 |
| 687.50 | 0.00 | 95.00 | — |
| 0.00 | 137.50 | 97.50 | — |
| 687.50 | 137.50 | 100.00 | 99.88 |
| 571.15 | 0.00 | 91.25 | — |
| 0.00 | 47.60 | 89.50 | — |
| 571.15 | 47.60 | 99.50 | 99.08 |
| 761.54 | 0.00 | 98.25 | — |
| 0.00 | 63.46 | 97.00 | — |
| 761.54 | 63.46 | 100.00 | 99.95 |
| 594.00 | 0.00 | 86.25 | — |
| 0.00 | 24.75 | 81.25 | — |
| 594.00 | 24.75 | 98.75 | 97.42 |
| 792.00 | 0.00 | 88.75 | — |
| 0.00 | 33.00 | 88.75 | — |
| 792.00 | 33.00 | 100.00 | 98.73 |

Being:
PANMA—Panicum maximum
grams of i.a./ha—grams of active ingredient per hectare

TABLE 7
Test results - Synergistic activity verified 35 days after application

Rate of Application

| | | |
|---|---|---|
| Amicarbazone | Flumioxazin | Control % |

| | |
|---|---|
| rate in grams of active | BRADC |

| | | |
|---|---|---|
| ingredient/ha | Observed | Expected |

| | | | |
|---|---|---|---|
| 238.00 | 0.00 | 52.50 | — |
| 0.00 | 380.00 | 90.00 | — |
| 238.00 | 380.00 | 100.00 | 95.25 |
| 442.00 | 0.00 | 66.25 | — |
| 0.00 | 176.80 | 92.75 | — |
| 442.00 | 176.80 | 100.00 | 97.55 |
| 515.60 | 0.00 | 62.50 | — |
| 0.00 | 103.10 | 83.75 | — |
| 515.60 | 103.10 | 100.00 | 93.91 |
| 571.15 | 0.00 | 77.50 | — |
| 0.00 | 47.60 | 81.25 | — |
| 571.15 | 47.60 | 100.00 | 95.78 |

Where:
BRADC—Brachiaria decumbens
grams of i.a./ha—grams of active ingredient per hectare

As can be concluded from the results presented above, the synergy between the compounds present in the composition that is the object of the present invention is confirmed for several proportions.

The choice of the preferred form of embodiment of this invention, described in this section is provided only as an example. Alterations, modifications and variations may be made to any other form of herbicide composition of the present invention of at least one herbicide belonging to the group whose mechanism of action acts as a photosystem II inhibitor in combination with at least one herbicide belonging to the group whose mechanism of action acts as inhibitor of the enzyme protoporphyrinogen oxidase, where such alterations can be determined by those skilled in the art without, however diverging from the objective revealed in the claim of this patent, which is exclusively defined by the attached claims.

1. A broad-spectrum synergistic herbicide composition for the control of weeds in agricultural crops, comprising:
1.0% to 99.0%, by weight of a first herbicide belonging to the group whose mechanism of action acts as a photosystem II inhibitor;
1.0% to 99.0%, by weight of a second herbicide belonging to the group whose mechanism of action acts as an inhibitor of the enzyme protoporphyrinogen oxidase; and
an agrochomically acceptable vehicle;
wherein the quantities are based on the total mass of herbicide composition.

2. The herbicide composition according to claim 1, wherein the proportion, by weight, between the first herbicide and the second herbicide from 5 to 6 parts to 1 part.

3. The herbicide composition according to claim 1, wherein the first herbicide is a triazines.

4. The herbicide composition according to claim 3, wherein the first herbicide is amicarbazone.

5. The herbicide composition according to claim 1, wherein the second herbicide is a cyclohexene dicarboximides.

6. The herbicide composition, according to claim 5, wherein the second herbicide is flumioxazin.

7. The herbicide composition according to claim 1, comprising 700 g amicarbazone and 125 g flumioxazin per ai/ha.

8. A method of applying an herbicide comprising applying the herbicide composition of claim 1, prior to planting or to agriculture.

9. The method of claim 8, wherein applying combats weeds present in agriculture crops.

10. A method of applying the herbicide composition of claim 1, comprising:
a) electing an area of an agricultural crop; and
b) applying an herbicidally effective quantity of the herbicide composition of claim 1 to the plants and/or directly to the environment/location/soil.
